(19) United States
(12) Patent Application Publication
(10) Pub. No.: US 2004/0036917 A1
(43) Pub. Date: Feb. 26, 2004

(54) Variable printing processing apparatus, and variable printing processing program storage medium

(75) Inventor: Tetsuya Sano, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/638,330

(22) Filed: Aug. 12, 2003

(30) Foreign Application Priority Data
Aug. 23, 2002 (JP) 2002-243034

(51) Int. Cl. B41F 1/00; G06F 15/00

(52) U.S. Cl. 358/1.18; 358/1.12

(57) ABSTRACT

An object table obtaining section obtains an object table representative of a list of objects to be sequentially replaced. A replacement subject frame creating section creates a replacement subject frame having a same size as a size of the objects to be sequentially replaced and transfers the replacement subject frame to an editing apparatus for editing images. An edited image data obtaining section obtains edited image data representative of an edited image including the replacement subject frame, which is edited in the editing apparatus. A variable printing image data creating section creates variable printing image data representative of an variable printing image in which the replacement subject frame of the edited image represented by the edited image data obtained in the edited image data obtaining section is replaced with the objects of the object table.

### BACKGROUND OF THE INVENTION

1. Field of the Invention

The present invention relates to a variable printing processing apparatus for creating variable printing image data representative of a plurality of variable printing images in which a part is replaced, and an image processing program storage medium storing an image processing program which causes an information processing apparatus to operate as such a variable printing processing apparatus when the image processing program is loaded onto the information processing apparatus.

2. Description of the Related Art

Hitherto, there is known a variable printing processing apparatus for creating variable printing image data representative of a plurality of variable printing images in which a part is replaced, of which a direct mail is typical. To create the variable printing image data, there is defined a special page description language for variable printing. A variable printing processing apparatus creates the variable printing image data representative of a plurality of variable printing images in such a manner that a part of the variable printing images, which is subjected to a page editing using the special page description language, is replaced. The created variable printing image data is outputted to a raster image processor (RIP) apparatus that is capable of interpreting the special page description language. The RIP apparatus converts the variable printing image data into raster image data for printing and outputs the raster image data to a printer. The printer prints an image (a halftone dot image) consisting of raster image data on a designated printing paper. Thus, the printer prints on a plurality of printing papers a plurality of variable printing images in which a part is replaced. As the printer, a so-called on-demand-printing printer, which is capable of immediately printing necessary information at necessary time, is used.

In the printing trade, there is widely used a DTP (Desk Top Publishing) system wherein a personal computer and the like is used to perform editing and printing of documents. In the DTP system, an all-purpose editing software (a DTP editing application) is used on an editing workstation such as a personal computer to perform editing works for determining layout of a pattern representative of an image, a text, and a line subject, using an all-purpose PDL (Page Description Language). A result of the editing works is outputted in form of PS (PostScript) data and PDF (Portable Document Format) data. The RIP apparatus converts those data into printing raster image data to be printed. When it is intended that such a DTP system is used to create variable printing data, there is a need that various types of all-purpose DTP editing applications, which come onto the market, are associated with the above-mentioned special page description language. Accordingly, there is a problem that this is poor in general-purpose properties.

### SUMMARY OF THE INVENTION

In view of the foregoing, it is an object of the present invention to provide a variable printing processing apparatus and an image processing program storage medium storing an image processing program, which are capable of creating variable printing data using all-purpose DTP editing applications without an application of the special association.

To achieve the above-mentioned object, the present invention provides a variable printing processing apparatus that creates variable printing image data representative of a plurality of variable printing images in which a part is replaced, the variable printing processing apparatus comprising:

an object table obtaining section that obtains an object table representative of a list of objects to be sequentially replaced;

a replacement subject frame creating section that creates a replacement subject frame having a same size as a size of the objects to be sequentially replaced and transfers the replacement subject frame to an editing apparatus for editing images;

an edited image data obtaining section that obtains edited image data representative of an edited image including the replacement subject frame, which is edited in the editing apparatus; and

a variable printing image data creating section that creates variable printing image data representative of an variable printing image in which the replacement subject frame of the edited image represented by the edited image data obtained in the edited image data obtaining section is replaced with the objects of the object table.

In the variable printing processing apparatus according to the present invention as mentioned above, it is preferable that the object table obtaining section obtains the object table through permitting a double registration of the same object.

In the variable printing processing apparatus according to the present invention as mentioned above, it is preferable that the object table obtaining section obtains the object table on a basis of classification of objects, and

the replacement subject frame creating section that creates, when the object table obtaining section obtains a plurality of object tables, a plurality of replacement subject frames associated with the plurality of object tables, and transfers the replacement subject frames to the editing apparatus.

The “obtaining” referred to in the present invention means creation according to an operation, reading of tables previously created and stored, and receiving tables created in the exterior.

To achieve the above-mentioned object, the present invention provides a variable printing processing program storage medium storing a variable printing processing program which causes an information processing apparatus to operate as a variable printing processing apparatus that creates variable printing image data representative of a plurality of variable printing images in which a part is replaced, when the variable printing processing program is incorporated into the information processing apparatus and is executed, the variable printing processing apparatus comprising:

an image data obtaining section that obtains the printing image data;

an image data conversion section that converts the printing image data obtained in the image data obtaining section into the proof image data through processing of the printing image data presupposing a reproduction system for the printed image in the output device;

an additional image data creating section that creates additional image data for the output device, which is representative of an additional image describing a reproduction property of a spot color in the reproduction system presupposed when the image data conversion section processes printing image data; and

an image data output section that outputs to the output device the proof image data converted in the image data conversion section and the additional image data created in the additional image data creating section, so that the output device outputs the proof image and the additional image.

In the variable printing processing program storage medium according to the present invention as mentioned above, it is preferable that the object table obtaining section obtains the object table through permitting a double registration of the same object.

In the variable printing processing program storage medium according to the present invention as mentioned above, it is preferable that the object table obtaining section obtains the object table on a basis of classification of objects, and

the replacement subject frame creating section that creates, when the object table obtaining section obtains a plurality of object tables, a plurality of replacement subject frames associated with the plurality of object tables, and transfers the replacement subject frames to the editing apparatus.

### BRIEF DESCRIPTION OF THE DRAWINGS

FIG. 1 is a system into which a variable printing processing apparatus according to an embodiment of the present invention is incorporated.

FIG. 2 is a hardware structural view of an information processing apparatus shown in FIG. 1.

FIG. 3 is a conceptual view of a CD-ROM storing a variable printing processing program stored in a variable printing processing program storage medium according to one embodiment of the present invention.

FIG. 4 is a view showing structure of a variable printing processing apparatus according to an embodiment of the present invention.

FIG. 5 is a view useful for understanding set up of “parts groups” in the variable printing processing apparatus shown in FIG. 4 and a state that an image as the parts is registered.

FIG. 6 is a view useful for understanding set up of “parts group” in the variable printing processing apparatus shown in FIG. 4 and a state that a text as the parts is registered.

FIG. 7 is a view showing a layout of the parts group in the variable printing processing apparatus shown in FIG. 4.

FIG. 8 is a view showing a variable printing image consisting of a variable printing image data created in accordance with PDF data from an editing apparatus, of the variable printing processing apparatus.

FIG. 9 is a view showing a structure of an example of an object table displayed on a screen by a GUI accompanying the variable printing processing apparatus.

### DETAILED DESCRIPTION OF PREFERRED EMBODIMENTS

Embodiments of the present invention will be described with reference to the accompanying drawings.

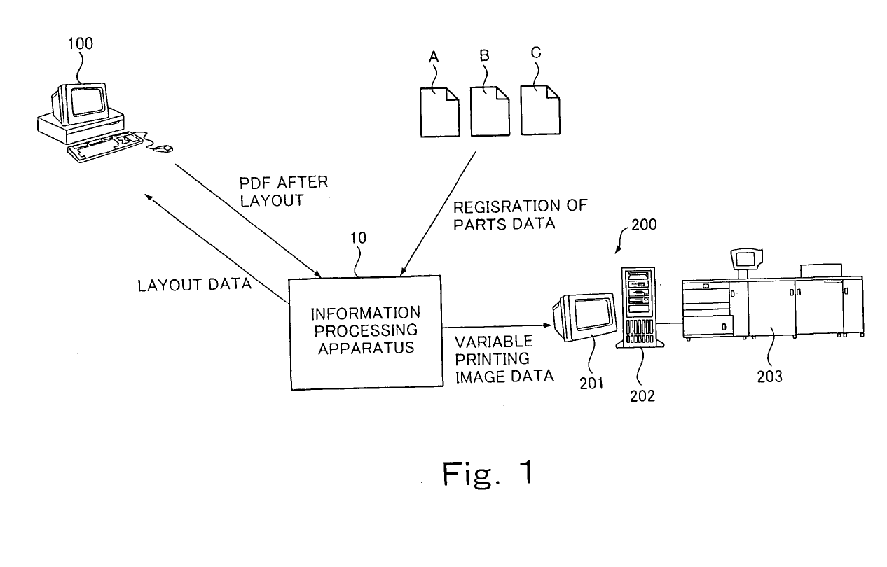

FIG. 1 is a system into which a variable printing processing apparatus according to an embodiment of the present invention is incorporated.

The system shown in FIG. 1 comprises an editing apparatus 100, an information processing apparatus 10, and a RIP apparatus 200. The RIP apparatus 200 comprises a monitor 201, a main frame 202 and a printer 203.

The editing apparatus 100 is a personal computer for performing the editing for a page layout. An all-purpose DTP editing application (an editing software) is used for the editing apparatus 100.

The information processing apparatus 10 incorporates thereinto a variable printing processing apparatus according to an embodiment of the present invention. The variable printing processing apparatus, which is incorporated in the information processing apparatus 10, creates variable printing image data representative of a plurality of variable printing image in which a part is replaced. Parts data A, B and C representative of objects (which are referred to as parts) are registered with the variable printing processing apparatus. Details of those parts data A, B and C and an exchange of data between the variable printing processing apparatus and the editing apparatus 100 will be described latter.

The RIP apparatus 200 displays on the monitor 201 the variable printing image data created in the variable printing processing apparatus incorporated into the information processing apparatus 10, and converts the variable printing image data into raster image data for printing in the main frame 202 and outputs the converted image data to the printer 203. The printer 203 is a so-called on-demand-printing printer, which is capable of immediately printing necessary information at necessary time. The printer 203 prints on a printing paper an image (a halftone dot image) consisting of the raster image data.

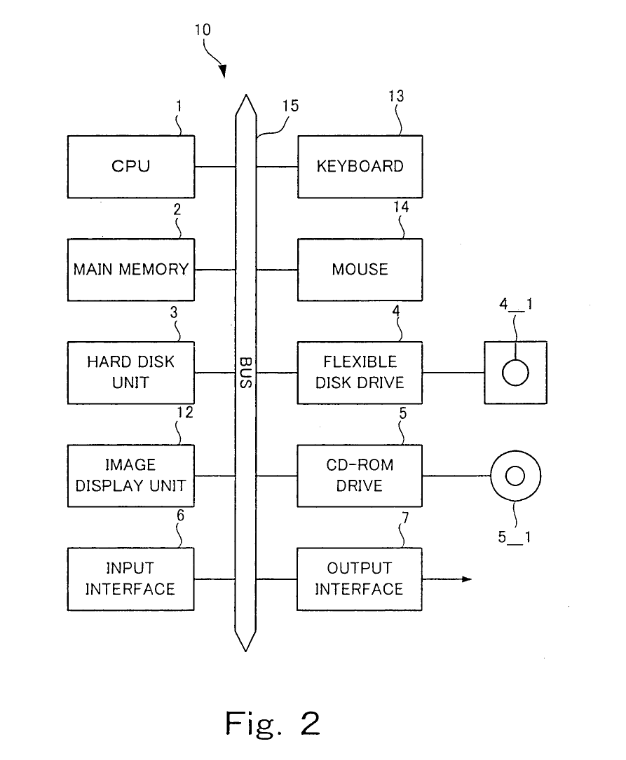

FIG. 2 is a hardware structural view of an information processing apparatus shown in FIG. 1.

The information processing apparatus 10 comprises: a CPU (central processing unit) 1 for executing various sorts of program; a main memory 2 in which a program stored in a hard disk unit 3 is read and is developed for execution by the CPU 1; the hard disk unit 3 storing various sorts of programs and data; a flexible disk drive 4 for accessing a flexible disk 4_1 mounted on the flexible disk drive 4; a CD-ROM drive 5 for accessing a CD-ROM 5_1 mounted on the CD-ROM drive 5; an input interface 6 connected to the editing apparatus 100 shown in FIG. 1 to receive edited image data (PDF data subjected to layout) from the editing apparatus 100; and an output interface 7 connected to the RIP apparatus 200 to transmit variable printing image data to the RIP apparatus 200. Those elements are connected to one another via a bus 15, and also connected to an image display unit 12, a keyboard 13 and a mouse 14, which are also shown in FIG. 2.

The CD-ROM 5_1 stores therein a variable printing processing program which causes the information processing apparatus 10 to operate as an embodiment of a variable printing processing apparatus according to the present invention. The CD-ROM 5_1 is mounted on the CD-ROM drive 5 so that the variable printing processing program stored in the CD-ROM 5_1 is uploaded onto the information processing apparatus 10 and is stored in the hard disk unit 3. When the variable printing processing program stored in stored in the hard disk unit 3 is executed in the information processing apparatus 10, the information processing apparatus 10 serves as an embodiment of a variable printing processing apparatus according to the present invention.

Here, there will be explained the variable printing processing program to be executed in the information processing apparatus 10, which corresponds to the variable printing processing program stored in an embodiment of the variable printing processing program storage medium of the present invention.

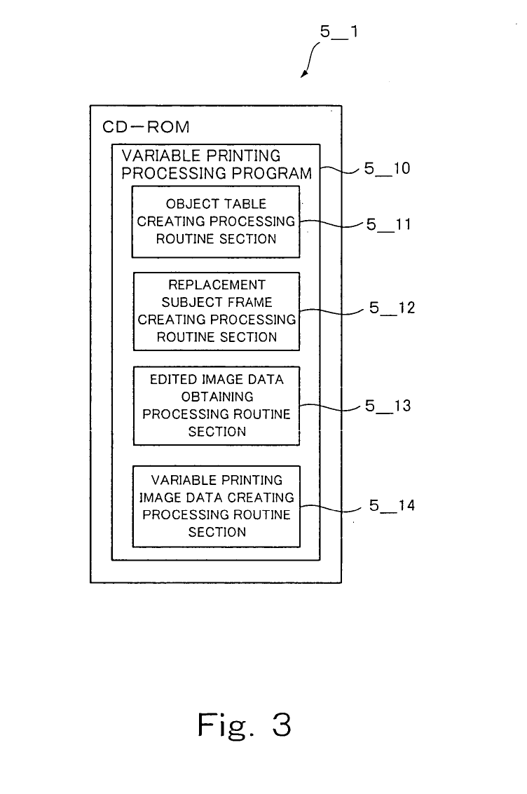

FIG. 3 is a conceptual view of a CD-ROM storing a variable printing processing program stored in a variable printing processing program storage medium according to one embodiment of the present invention.

A variable printing processing program 5_10 is stored in the CD-ROM 5_1 shown in FIG. 3. The variable printing processing program 5_10 comprises an object table creating processing routine section 5_11, a replacement subject frame creating processing routine section 5_12, an edited data obtaining processing routine section 5_13, and a variable printing image data creating processing routine section 5_14. Details of the variable printing processing program 5_10 will be described in conjunction with the effect of the respective elements of an embodiment of an image processing apparatus of the present invention.

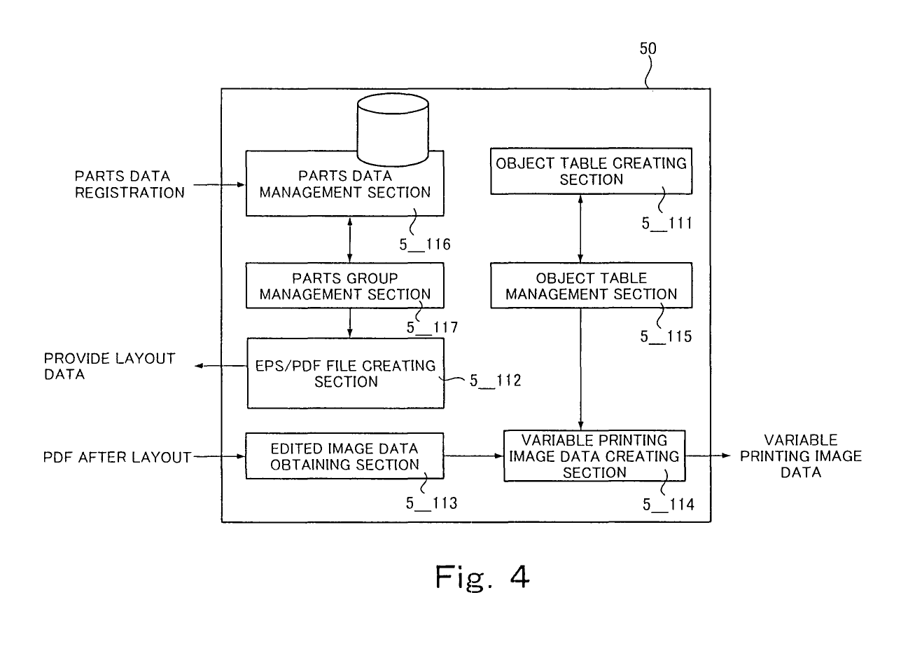

FIG. 4 is a view showing structure of a variable printing processing apparatus according to an embodiment of the present invention.

A variable printing processing apparatus 50 shown in FIG. 4 has an object table creating section 5_111 (an example of the object table obtaining section referred to in the present invention). The object table creating section 5_111 operates in response to an effect of the program of the object table creating processing routine section 5_shown in FIG. 3 to create an object table representative of a list of objects (parts) to be replaced sequentially in accordance with an operation. In details, the object table creating section 5_111 creates the object table through permitting a double registration of the same object. Further, the object table creating section 5_111 may create the object table classifying objects. Incidentally, as classification of the objects, there are raised images, texts, graphics, and pages. An object table management section 5_115 manages the object table created in the object table creating section 5_111. Details of the object table, and operations for creating the object table will be described latter.

The variable printing processing apparatus 50 has further a parts data management section 5_116 for registering and managing parts data A, B and C (cf. FIG. 1) representative of objects (parts) from the exterior, and a parts group management section 5_117 for managing “parts group” (corresponding to the replacement subject frame referred to in the present invention) that is a site corresponding to the replacement portion of parts of the variable printing page.

The variable printing processing apparatus 50 has furthermore a parts group layout use EPS and PDF file creating section 5_112 (hereinafter, it is referred to as an EPS/PDF file creating section 5_112). The EPS/PDF file creating section 5_112 corresponds to the replacement subject frame creating section referred to in the present invention. The EPS/PDF file creating section 5_112 operates in response to an effect of the program of the replacement subject frame creating processing routine section 5_12 shown in FIG. 3 to create a replacement subject frame having the same size as the parts to be sequentially replaced, and provides the created replacement subject frame to the editing apparatus 100 (cf. FIG. 1) for editing an image in form of layout data. Further, more in detail, when the object table creating section 5_111 creates a plurality of object tables, the EPS/PDF file creating section 5_112 creates a plurality of “parts groups” associated with the plurality of object tables and transfers the same to the editing apparatus 100.

The variable printing processing apparatus 50 has still further an edited data obtaining section 5_113. The edited data obtaining section 5_113 operates in response to the program of the edited data obtaining processing routine section 5_13 shown in FIG. 3 to obtain PDF data subjected to the layout processing, which is the edited image data representative of the edited image including the “parts groups”, that is edited in the editing apparatus 100.

The variable printing processing apparatus 50 has still furthermore a variable printing image data creating section 5_114. The variable printing image data creating section 5_114 operates in response to the program of the variable printing image data creating processing routine section 5_14 shown in FIG. 3 to create variable printing image data representative of a variable printing image in which the “parts groups” of the edited image represented by the PDF data subjected to the layout processing, which is obtained in the edited data obtaining section 5_113, is replaced by the objects (parts) of the object table.

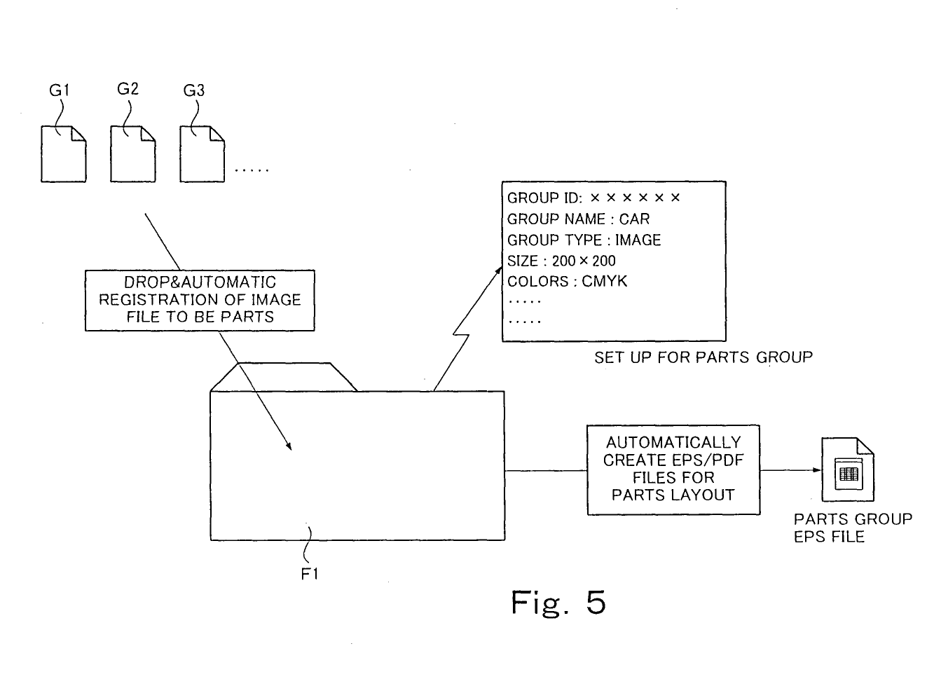

FIG. 5 is a view useful for understanding set up of the “parts groups” in the variable printing processing apparatus shown in FIG. 4 and a state that an image as the parts is registered.

In the event that an image (for example, an image of a car) is registered as parts with the variable printing processing apparatus 50, image files G1, G2, G3, . . . , which store therein images 1, 2, 3, . . . , as parts, respectively, are automatically registered by means of dropping those files into the parts group (car) use folder F1 (a registration folder) in the variable printing processing apparatus 50. Thus, there is carried out a set up for the parts group. In this case, there are set up xxxx (for example, a customer name) as a group ID capable of uniquely discriminating the parts group in the system, a car as a group name, an image as a group type, a numerical value 200×200 indicating of a size of a site wherein the parts group performs the replacement, and CMYK representative of attributes of colors. The parts layout use EPS/PDF file (“parts group”) is automatically created in accordance with information (attributes) thus set up. In this case, the parts group EPS file for an image, which is the replacement subject frame, is created. The created parts group EPS file is transferred to the editing apparatus 100.

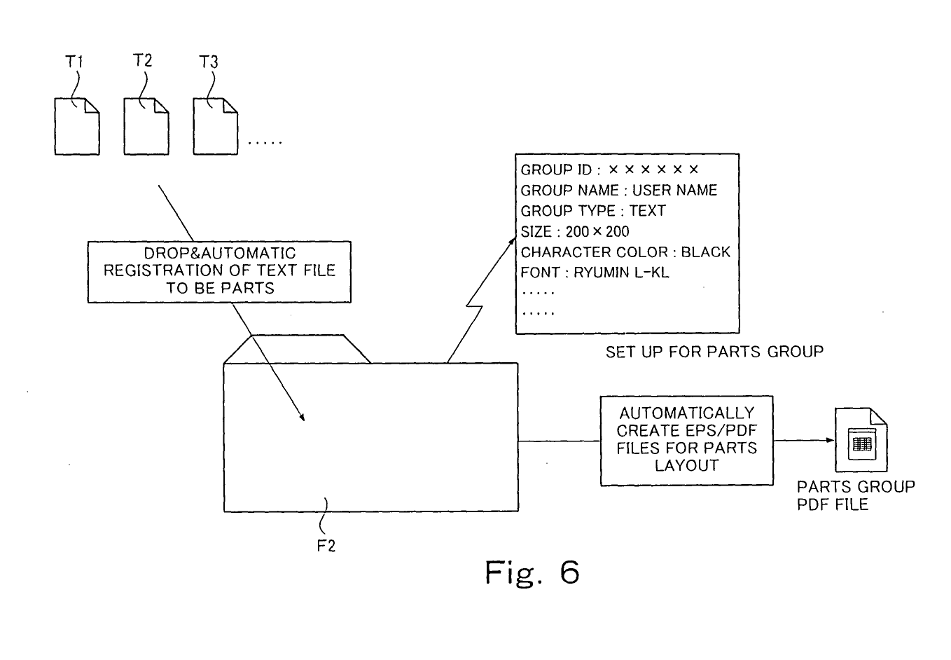

FIG. 6 is a view useful for understanding set up of “parts group” in the variable printing processing apparatus shown in FIG. 4 and a state that a text as the parts is registered.

In the event that a text (a character string) as parts is registered with the variable printing processing apparatus 50, text files T1, T2, T3, . . . , which store therein texts 1, 2, 3, . . . , as parts, respectively, are automatically registered by means of dropping those files into the parts group (user name) use folder F2 in the variable printing processing apparatus 50. Thus, there is carried out a set up for the parts group. In this case, there are set up xxxx as a group ID capable of uniquely discriminating the parts group in the system, a user name as a group name, a text as a group type, a numerical value 200×200 indicating of a size, black indicative of a character color, and Ryumin L-KL indicative of font. The parts layout use EPS/PDF file is automatically created in accordance with information (attributes) thus set up. In this case, the parts group PDF file for a text, which is the replacement subject frame, is created. The created parts group PDF file is also transferred to the editing apparatus 100.

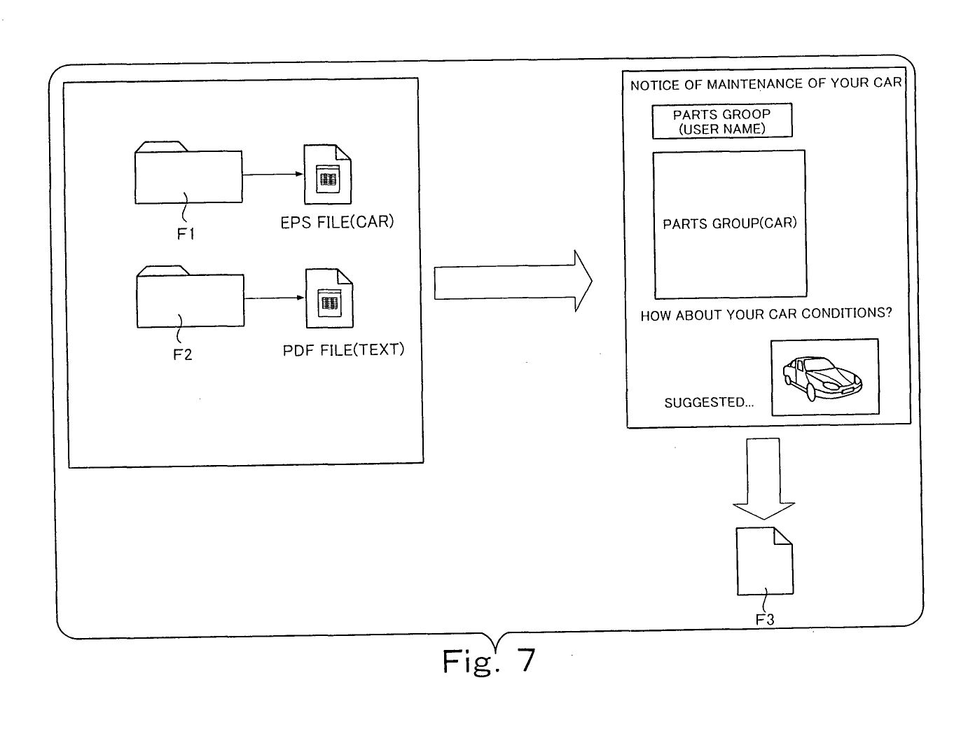

FIG. 7 is a view showing a layout of the parts group in the variable printing processing apparatus shown in FIG. 4.

The left side of FIG. 7 shows the parts group EPS file, which is created in accordance with information of the folder F1 for the parts group (car) shown in FIG. 5, and the parts group PDF file, which is created in accordance with information of the folder F2 for the parts group (text) shown in FIG. 6. Those EPS file and PDF file are transferred to the editing apparatus 100. In the editing apparatus 100, an all-purpose DTP editing application (an editing software) is used to put the EPS file and the PDF file in form of frames of blank as shown at the right side of FIG. 7, that is, to ensure places, so that a layout editing as a model for a variable printing is performed. Incidentally, with respect to portions other than the parts groups, the conventional editing is performed. After the completion of the editing, PDF data constituting a PS file F3 representative of a page to be a model is outputted from the editing apparatus 100 to the variable printing processing apparatus 50.

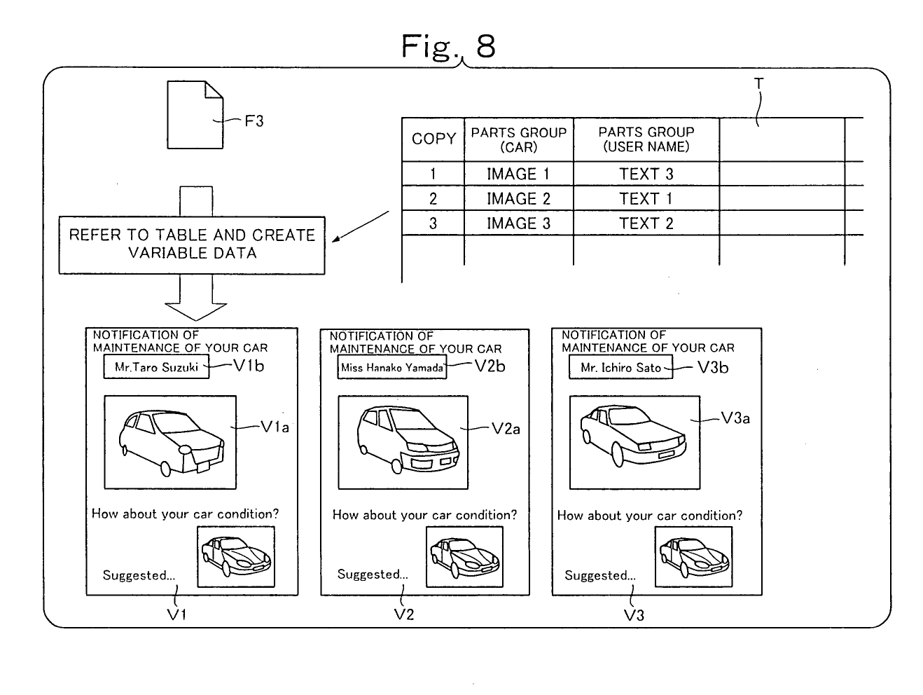

FIG. 8 is a view showing a variable printing image consisting of a variable printing image data created in accordance with PDF data from an editing apparatus, of the variable printing processing apparatus.

As explained in conjunction with FIG. 7, the PDF data constituting the PS file F3 representative of a page to be a model is outputted from the editing apparatus 100 to the variable printing processing apparatus 50. The variable printing processing apparatus 50 is provided with an object table T as shown in FIG. 8, which is created in the object table creating section 5_111 (cf. FIG. 4). The object table T has a pair of image 1 for printing (copying) on a first printing paper and text 3, a pair of image 2 for printing on a second printing paper and text 1, and a pair of image 3 for printing on a third printing paper and text 2. When the variable printing processing apparatus 50 receives the PS file F3 representative of a page to be a model from the editing apparatus 100, the variable printing processing apparatus 50 refers to the object table T, and creates, as shown in FIG. 8, variable printing image data V1, V2 and V3 representative of variable printing images to be printed on the first, second and third printing papers, respectively. The variable printing image data V1 has parts data V1a representative of image 1 and parts data V1b representative of text 3. The variable printing image data V2 has parts data V2a representative of image 2 and parts data V2b representative of text 1. The variable printing image data V3 has parts data V3a representative of image 3 and parts data V3b representative of text 2.

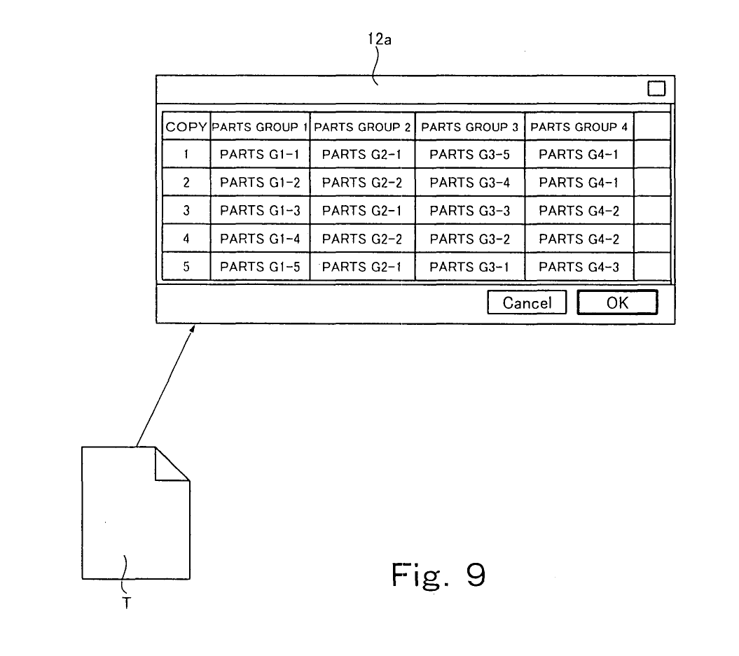

FIG. 9 is a view showing a structure of an example of an object table displayed on a screen by a GUI (Graphical User Interface) accompanying the variable printing processing apparatus.

On a screen 12a of the image display unit 12 (cf. FIG. 2) constituting the information processing apparatus 10 incorporating thereinto the variable printing processing apparatus 50, there is displayed an example of the object table T indicative of a list of parts. The object table T consists of four sorts of parts groups 1, 2, 3 and 4. The parts group 1 consists of mutually different parts G1-1 to G1-5. Also the parts group 3 consists of mutually different parts G3-5 to G3-1. On the other hand, the parts group 2 consists of three same parts G2-1 and two same parts G2-2. The parts group 4 consists of two same parts G4-1, two same parts G4-2, and one part G4-1. As mentioned above, it is acceptable that the object table T is created permitting the double registration of the same parts or on a basis of classification of the parts. This makes it possible to simply create variable printing image data in which for example only the text (customer name) is replaced and the image (car) is the same. In this case, if the same parts group is concerned, it is permitted to allot parts allotted to a copy page of a certain variable into another copy page. Selection of a desired part on the screen 12a displayed through the GUI by the mouse or the keyboard and designation of the OK button make it possible to obtain an object table in which a part is replaced by the desired.

As mentioned above, according to the present invention, it is possible to create variable printing data using the all-purpose editing application without applying the special association.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A variable printing processing apparatus that creates variable printing image data representative of a plurality of variable printing images in which a part is replaced, the variable printing processing apparatus comprising:
an object table obtaining section that obtains an object table representative of a list of objects to be sequentially replaced;
a replacement subject frame creating section that creates a replacement subject frame having a same size as a size of the objects to be sequentially replaced and transfers the replacement subject frame to an editing apparatus for editing images;
an edited image data obtaining section that obtains edited image data representative of an edited image including the replacement subject frame, which is edited in the editing apparatus; and
a variable printing image data creating section that creates variable printing image data representative of an variable printing image in which the replacement subject frame of the edited image represented by the edited image data obtained in the edited image data obtaining section is replaced with the objects of the object table.

2. A variable printing processing apparatus according to claim 1, wherein the object table obtaining section obtains the object table through permitting a double registration of the same object.

3. A variable printing processing apparatus according to claim 1, wherein the object table obtaining section obtains the object table on a basis of classification of objects, and
the replacement subject frame creating section that creates, when the object table obtaining section obtains a plurality of object tables, a plurality of replacement subject frames associated with the plurality of object tables, and transfers the replacement subject frames to the editing apparatus.

4. A variable printing processing program storage medium storing a variable printing processing program which causes an information processing apparatus to operate as a variable printing processing apparatus that creates variable printing image data representative of a plurality of variable printing images in which a part is replaced, when the variable printing processing program is incorporated into the information processing apparatus and is executed, the variable printing processing apparatus comprising:
an image data obtaining section that obtains the printing image data;
an image data conversion section that converts the printing image data obtained in the image data obtaining section into the proof image data through processing of the printing image data presupposing a reproduction system for the printed image in the output device;
an additional image data creating section that creates additional image data for the output device, which is representative of an additional image describing a reproduction property of a spot color in the reproduction system presupposed when the image data conversion section processes printing image data; and
an image data output section that outputs to the output device the proof image data converted in the image data conversion section and the additional image data created in the additional image data creating section, so that the output device outputs the proof image and the additional image.

5. A variable printing processing program storage medium according to claim 4, wherein the object table obtaining section obtains the object table through permitting a double registration of the same object.

6. A variable printing processing program storage medium according to claim 4, wherein the object table obtaining section obtains the object table on a basis of classification of objects, and
the replacement subject frame creating section that creates, when the object table obtaining section obtains a plurality of object tables, a plurality of replacement subject frames associated with the plurality of object tables, and transfers the replacement subject frames to the editing apparatus.
